(19) United States
(12) Patent Application Publication
(10) Pub. No.: US 2008/0222845 A1
(43) Pub. Date: Sep. 18, 2008

(54) Metal connecting piece

(75) Inventor: Serge Braun, Heusden (BE)

Correspondence Address: JAMES C. WRAY, 1493 CHAIN BRIDGE ROAD, SUITE 300, MCLEAN, VA, 22101, US

(73) Assignee: Moerman NV

(21) Appl. No.: 11/804,688

(22) Filed: May 18, 2007

(30) Foreign Application Priority Data
Mar. 12, 2007 (BE) 2007/0106

(51) Int. Cl. F16C 7/00

(52) U.S. Cl. 16/404

(57) ABSTRACT

The invention relates to a metal connecting piece (1) for connecting a shaft or handle provided with external screw thread to an implement, in which the metal connecting piece comprises a first part (2) that is at least partially provided with internal screw thread (4) for screwing in of the shaft or handle provided with external screw thread, the connecting piece being provided with a second part (3) having an internal diameter (D2) that is different from the internal diameter (D1) of the abovementioned first part (2) at least partially provided with internal screw thread (4), and said second part (3) being provided for enclosing the shaft or handle. This invention also relates to a method for producing such a metal connecting piece.

The invention relates to a metal connecting piece for connecting a shaft or handle provided with external screw thread to an implement.

This invention relates in particular, but not limitatively, to a connecting piece for fixing a shaft or handle on a cleaning implement, such as, for example, a floor squeegee, or a garden implement, such as, for example, a shovel.

A first known manner of fixing on the implement a connecting piece for connecting a shaft or handle provided with external screw thread to said implement is to provide a bore in the implement and to glue the connecting piece in said bore. However, if a relatively heavy load is placed on the implement and/or if the implement comes into contact with certain chemicals, the glued connection can loosen. Furthermore, this method of connection is usable primarily in the case of implements with a wooden body (e.g. brushes), but is difficult to achieve when it is a matter of implements with a metal body, such as, inter alia, floor squeegees.

In case of known implements with a metal body (inter alia, floor squeegees) a socket likewise made of metal is therefore generally fixed on this body (for example, by means of a riveted or spot-welded connection), and said socket is provided for clamping a shaft or handle in it. For this purpose, said socket has a metal wall in which two openings running in the longitudinal direction are provided, so that there are two wall parts which can be bent towards each other until they are against the shaft in order to clamp said shaft. In order to move said wall parts into their clamping position and to retain them in that position, a clamping ring is provided around said wall parts, which clamping ring can be tightened by means of a tightening screw.

The disadvantage of this method of connection is, however, that the user wanting to prepare the implement for use needs a screwdriver in order to fix the shaft or handle on the implement. This is not a straightforward matter for some users.

Furthermore, the efficiency of the connection made in this way depends on the tension that is applied to the wall parts of the socket by means of the clamping ring. If the clamping ring is not tightened sufficiently, the shaft will easily disconnect from the implement.

A further disadvantage of this type of connection is that the tightening screw forms a part that projects laterally relative to the shaft or handle and the socket. When using the implement the user has to take care not to cause damage (for example to doors and furniture in case of a cleaning implement) with this projecting metal part. Furthermore, this metal projection is also a disadvantage from an aesthetic point of view.

The disadvantages of a connecting piece consisting of a socket and a clamping ring with tightening screw are at least partially solved already by means of an internally threaded connecting piece, which is then fixed on a shaft or handle, provided with external screw thread.

An implement provided with such a connecting piece with an internal screw thread can be connected by hand in a simple manner without any problem by almost anyone to an externally threaded shaft or handle, without the use of any tool.

Various connecting pieces made of plastic or metal (Al—Zn alloy) with an internal screw thread are already available on the market. These pieces are moulded or cast. The corresponding external screw thread is provided on the shaft or handle by fixing a threaded piece of moulded plastic or cast metal (Al—Zn alloy) provided with this external screw thread on the shaft or handle. The most commonly used threaded pieces commercially available are made of plastic, since these pieces can be produced more cheaply. The problem with such a connection between an existing connecting piece made of plastic or metal and a threaded piece made of plastic is, however, that the plastic threaded piece breaks off easily under the pressure with which the implement is handled during use.

The object of this invention is therefore to provide a metal connecting piece for connecting a shaft or handle provided with external screw thread to an implement, of which connection is sturdier than with known connecting pieces with an internal screw thread.

This object of the invention is achieved with a metal connecting piece for connecting a shaft or handle provided with external screw thread to an implement, in which the metal connecting piece comprises a first part that is at least partially provided with internal screw thread for screwing in of the shaft or handle provided with external screw thread, in which the connecting piece is provided with a second part having an internal diameter that is different from the internal diameter of the abovementioned first part at least partially provided with internal screw thread, and in which said second part is provided for enclosing the shaft or handle.

When the second part of the metal connecting piece encloses the shaft or handle in such a way, a threaded piece made of plastic cannot break off so easily, so that the connection of the connecting piece to the shaft or handle is sturdier than is the case with the known connecting pieces with an internal screw thread.

A particular embodiment of a metal connecting piece according to this invention, is provided with at least one groove on two virtually opposite sides of the wall of the first part in order to form the internal screw thread.

In such a way an internal screw thread is provided in a simple manner, which screw thread still ensures a sufficiently sturdy connection of the connecting piece to the shaft or handle.

In a specific embodiment of a metal connecting piece according to this invention the external screw thread of the shaft or handle is ACME screw thread.

Such an ACME screw thread can be provided in an extremely advantageous manner according to the invention.

In a preferred embodiment of a metal connecting piece according to this invention the connecting piece comprises one or more connecting elements which are provided for fixing the connecting piece on the implement.

With such connecting elements the connecting piece can be fixed on the implement, for example by welding or by riveting. Such a connecting element is then preferably in contact with the implement over a certain surface.

In a particular embodiment of a metal connecting piece according to this invention the implement is a cleaning implement, in particular a floor squeegee or window squeegee.

Such a connecting piece preferably comprises at least a first connecting element, which is provided for being attached to the front side of a floor squeegee or window squeegee, and at least a second connecting element, which is provided for being attached to the opposite side (rear side) of the floor squeegee or window squeegee.

Such connecting elements readily absorb the forces to which the connecting piece is subjected during use of the floor squeegee or window squeegee, so that a sturdy connection is obtained.

The object of this invention is furthermore also achieved by providing a method for producing a metal connecting piece according to this invention, in which the connecting piece is produced by means of folding a cut-out sheet metal blank.

An extremely advantageous connecting piece compared with the existing connecting pieces with internal screw thread is obtained in this way.

In a preferred method according to this invention, the folding process of the cut-out sheet metal blank, in which said blank comprises a first part and a second part of such width that after the folding process the first part and the second part of the connecting piece are formed, and in which the internal diameter of the second part is greater than the internal diameter of the first part of the connecting piece, comprises at least the following production steps:
a) stepwise folding of the second part of the sheet metal blank in such a way that the internal diameter of the second part of the connecting piece to be formed is determined;
b) folding round the sheet metal blank in such a way that the first part and the second part of the connecting piece are formed;
c) plastic deformation of the formed first part and second part of the connecting piece in such a way that said parts can no longer spring open;
d) at least partial provision of internal screw thread in the first part of the connecting piece.

In a method according to this invention the first part and the second part preferably comprise lateral edges, the first part and second part of the connecting piece being plastically deformed in such a way that the lateral edges of said parts virtually touch each other.

In a specific method according to this invention the sheet metal blank is provided with one or more lips which, after the folding process of the sheet metal blank, form the one or more connecting elements, the folding of said lips to form the one or more connecting elements being performed during the folding process of the sheet metal blank to form the connecting piece.

In a particular embodiment according to this invention the sheet metal blank is provided with at least a first lip which, after the folding process of the sheet metal blank, forms the abovementioned first connecting elements, the folding of said first lip(s) being performed during the stepwise folding of the second part of the sheet metal blank (step a) with such a fold angle that, after folding of the sheet metal blank to form the connecting piece, the abovementioned connecting elements can be fixed on the front side of the floor squeegee or window squeegee.

The sheet metal blank is preferably furthermore provided with at least two second lips extending around the abovementioned first lip(s) which second lips, after the folding process of the sheet metal blank, form further abovementioned connecting elements, the folding of said second lips being performed in two steps:
1. flattening the second lips after the plastic deformation of the first part and second part of the connecting piece (step c)
2. folding over the second connecting elements with such a fold angle that said connecting elements can be fixed on the rear side of the floor squeegee or window squeegee.

In an advantageous embodiment according to this invention the folding round of the sheet metal blank (step b) is carried out in various successive moulds.

In a further special method according to this invention the internal screw thread is at least partially produced by means of a mandrel which is provided with a corresponding external screw thread, in this way at least two grooves being made in the sheet metal blank.

Furthermore, in such a method according to this invention the lateral edges which substantially touch each other after the plastic deformation of the sheet metal blank are preferably welded together by laser welding.

In this way it is no longer possible to press the lateral edges apart when the shaft or handle is placed in the connecting piece, or under pressure during use of the implement.

This invention is now explained further with reference to the detailed description below of a number of preferred embodiments of a metal connecting piece for connecting a shaft or handle provided with external screw thread to an implement according to this invention. The aim of this description is purely to give clarifying examples and to indicate further advantages and details of these embodiments for a metal connecting piece for connecting a shaft or handle provided with external screw thread to an implement, and can therefore in no way be interpreted as a limitation of the field of application of the invention and of the patent rights applied for in the claims.

In this detailed description reference is made by means of reference numerals to the appended drawings, in which:

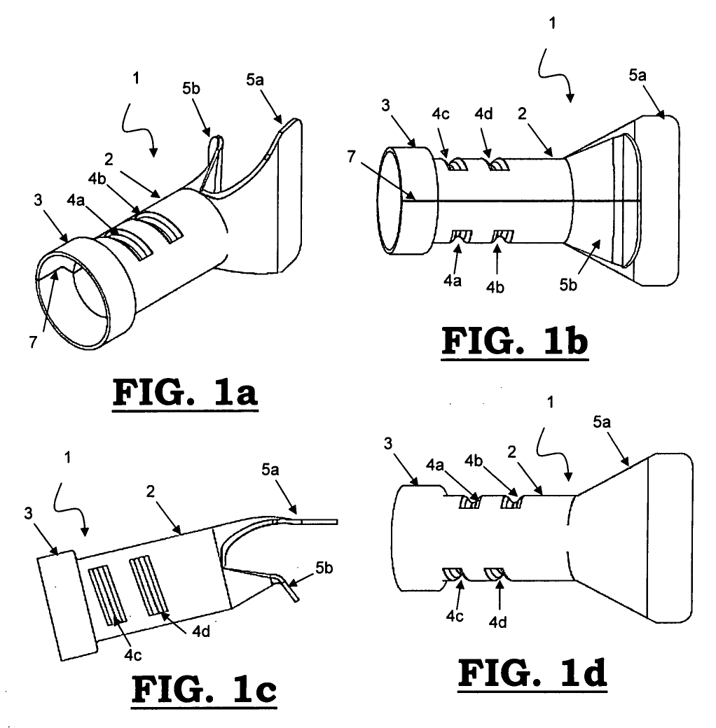

FIG. 1a is a perspective side view of a preferred embodiment of a connecting piece according to this invention;

FIG. 1b is a rear view of the connecting piece of FIG. 1a;

FIG. 1c is a side view of the connecting piece of FIG. 1a;

FIG. 1d is a front view of the connecting piece of FIG. 1a;

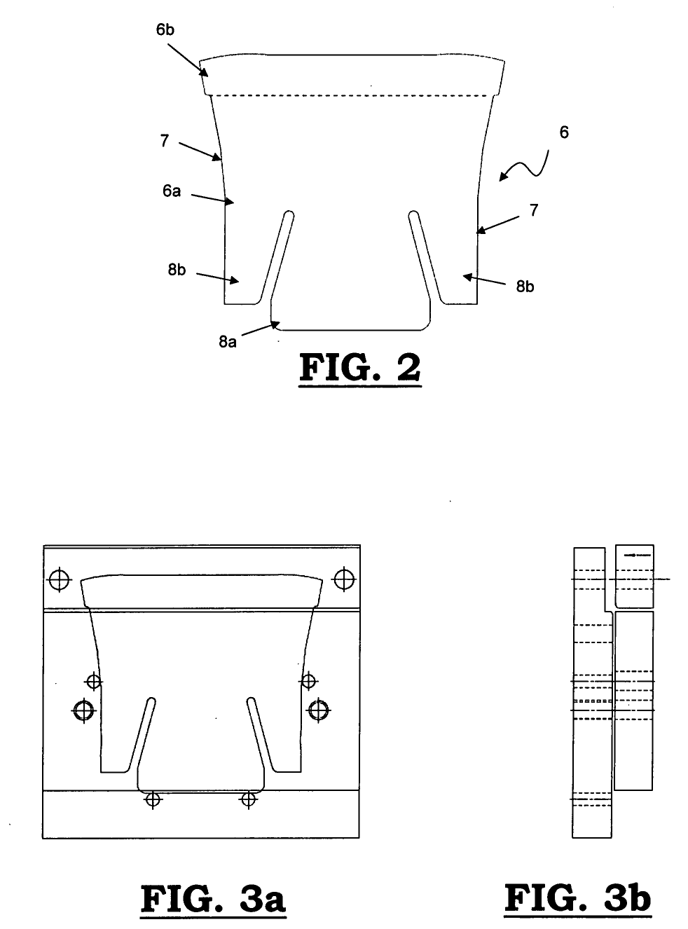

FIG. 2 is an elevational view of the sheet metal blank of the connecting piece of FIG. 1a;

FIG. 3a is a top view of the folding blank for stepwise folding of the second part of the sheet metal blank of FIG. 2;

FIG. 3b is a side view of the folding blank of FIG. 3a;

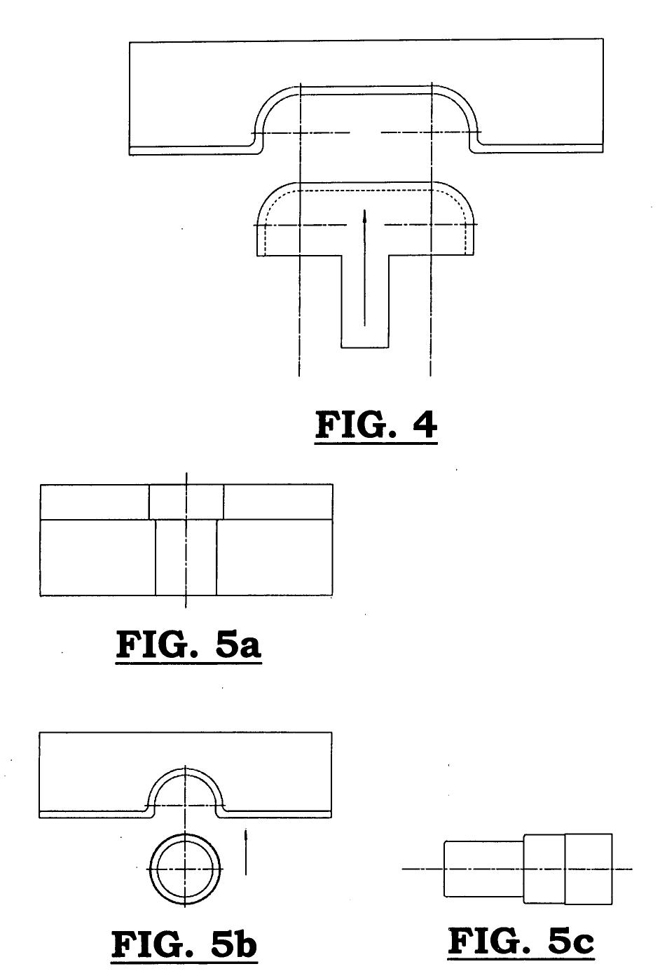

FIG. 4 is a cross section of a first mould and die by means of which the sheet metal blank is partially folded round;

FIG. 5a is a bottom view of a second mould by means of which the sheet metal blank which was partially folded round is folded round further;

FIG. 5b is a front view of the second mould of FIG. 5a and the corresponding die;

FIG. 5c is a side view of the die of FIG. 5b;

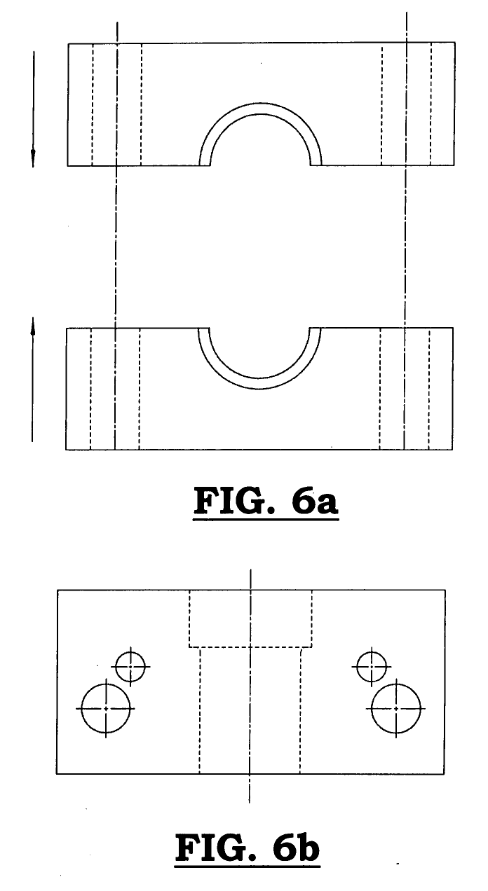

FIG. 6a is a front view of a split mould by means of which the blank folded round is plastically deformed;

FIG. 6b is a side view of the split mould of FIG. 6a;

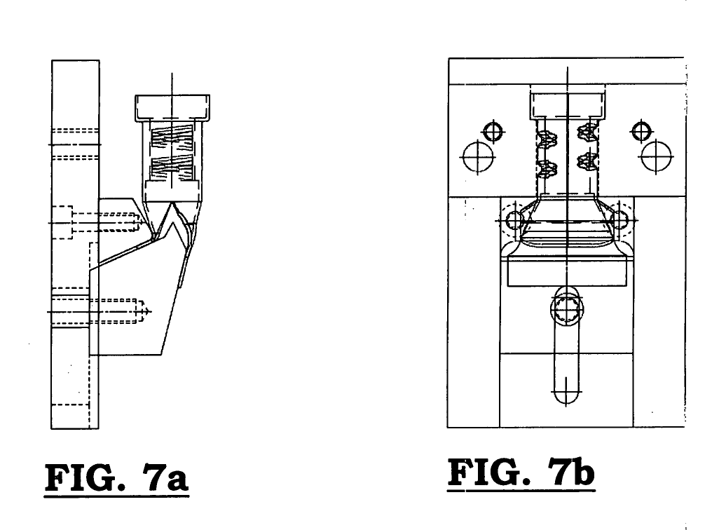

FIG. 7a is a side view of the folding device with which the lips are folded into their final shape.

FIG. 7b is a top view of the folding device of FIG. 7a.

The metal connecting piece (1) of the embodiment of this invention illustrated in FIG. 1a to 1d for connecting a shaft or handle provided with external screw thread to a floor squeegee or window squeegee comprises a first part (2) which is at least partially provided with internal screw thread (4) for screwing in of the shaft or handle provided with external screw thread, and comprises a second part (3) with an internal diameter (D2) which is different from the internal diameter (D1) of the abovementioned first part (2) at least partially provided with internal screw thread (4), said second part (3) being provided for enclosing the shaft or handle.

The internal screw thread (4) of this embodiment of a connecting piece according to this invention is formed by four grooves (4a-4d), which are provided in pairs on two opposite sides of the wall of the first part (2).

The metal connecting piece (1) of these figures is provided with two connecting elements (5a-b) which are provided for fixing the connecting piece on the implement, for example by riveting with rivets or by welding, the first connecting element (5a) being provided for fixing on the front side of the floor squeegee or window squeegee, and the second connecting element (5b) being provided for fixing on the opposite side (rear side) of the floor squeegee or window squeegee.

Such a connecting piece (1) according to this invention, as shown in FIGS. 1a to 1d is produced using the equipment illustrated in FIGS. 3 to 7b, by means of folding a cut-out sheet metal blank (6), as illustrated in FIG. 2.

The cut-out sheet metal blank (6), as illustrated in FIG. 2, is not a fold-out of the connecting piece (1) illustrated in FIGS. 1a to 1d, since during the folding round and plastic shaping of the blank (6) material is pressed outwards at various points by plastic deformation. In order to obtain an attractive cylindrical shape at the end, it is therefore necessary to start with a blank (6), in which zones with additional material are provided and zones in which less material is provided.

The cut-out sheet metal blank (6) of FIG. 2 is provided with three lips (8a-15b) which, after the folding process of the sheet metal blank (6), form the one or more connecting elements (5a-b).

The folding process of the cut-out sheet metal blank (6), which blank (6) comprises a first part (6a) and a second part (6b) of such width that after the folding process the first part (2) and the second part (3) of the connecting piece (1) are formed by means of the tools illustrated in FIGS. 3 to 7b, the internal diameter (D2) of the second part (3) being greater than the internal diameter (D1) of the first part (2) of the connecting piece (1), comprises the following production steps:
a) stepwise folding of the second part (6b) of the sheet metal blank (6) by means of the folding device as shown in FIGS. 3a and 3b, in such a way that the internal diameter (D2) of the second part (3) of the connecting piece (1) to be formed is determined;
a′) folding of the abovementioned first lip(s) (8a) during the stepwise folding of the second part (6b) of the sheet metal blank (6) (step a) with such a fold angle that after the folding of the sheet metal blank (6) to the form of the connecting piece (1) the abovementioned connecting elements (5a) can be fixed on the front side of the floor squeegee or window squeegee.
b) partial folding round of the sheet metal blank (6) by means of the mould and die of FIG. 4;
b′) further folding round of the sheet metal blank (6) by means of the mould and die of FIGS. 5a-c;
c) plastic deformation of the formed first part (2) and second part (3) of the connecting piece (1) by means of the split mould of FIGS. 6a-b, in such a way that said parts can no longer spring open. The first part (2) and second part (3) of the connecting piece (1) comprise lateral edges (7) here, the first part (2) and second part (3) of the connecting piece (1) being plastically deformed in such a way that the lateral edges (7) of said parts (2, 3) virtually touch each other.
c′) flattening of lips (8b);
c″) after the flattening of the second connecting elements (5b), said connecting elements are folded over with a folding device such as shown in FIGS. 7a-b with such a fold angle that said connecting elements can be fixed to the rear side of the floor squeegee or window squeegee.
d) at least partial provision of internal screw thread (4) in the first part (2) of the connecting piece (1) by means of a mandrel which is provided with a corresponding external screw thread, in this way at least two grooves being made in the sheet metal blank (6);
e) welding together by means of laser welding the lateral edges (7) which after the plastic deformation of the sheet metal blank (6) substantially touch each other.

As already indicated, this invention is not limited to the embodiments described above which were illustrated in the figures, and which already allow for a number of variants.

1. Metal connecting piece (1) for connecting a shaft or handle provided with external screw thread to an implement, in which the metal connecting piece comprises a first part (2) that is at least partially provided with internal screw thread (4) for screwing in of the shaft or handle provided with external screw thread, wherein the connecting piece is provided with a second part (3) having an internal diameter (D2) that is different from the internal diameter (D1) of the abovementioned first part (2) at least partially provided with internal screw thread (4), said second part (3) being provided for enclosing the shaft or handle.

2. Metal connecting piece (1) according to claim 1, wherein in order to form the internal screw thread (4) the metal connecting piece is provided with at least one groove (4a-d) on two virtually opposite sides of the wall of the first part (2).

3. Metal connecting piece (1) according to claim 1, wherein the external screw thread of the shaft or handle is ACME screw thread.

4. Metal connecting piece (1) according to one of claim 1, wherein the connecting piece (1) comprises one or more connecting elements (5a-b) which are provided for fixing the connecting piece on the implement.

5. Metal connecting piece (1) according to claim 1, wherein the implement is a cleaning implement, in particular a floor squeegee or window squeegee.

6. Metal connecting piece (1) according to claim 4, wherein the connecting piece (1) comprises at least a first connecting element (5a), which is provided for being attached to the front side of a floor squeegee or window squeegee, and at least a second connecting element (5b), which is provided for being attached to the opposite side (rear side) of the floor squeegee or window squeegee.

7. Method for producing a metal connecting piece (1) according to claim 1, wherein the connecting piece (1) is produced by means of folding a cut-out sheet metal blank (6).

8. Method according to claim 7, wherein the folding process of the cut-out sheet metal blank (6), in which said blank (6) comprises a first part (6a) and a second part (6b) of such width that after the folding process the first part (2) and the second part (3) of the connecting piece (1) are formed, and in which the internal diameter (D2) of the second part (3) is greater than the internal diameter (D1) of the first part (2) of the connecting piece (1), comprises at least the following production steps:
a) stepwise folding of the second part (6b) of the sheet metal blank (6) in such a way that the internal diameter (D2) of the second part (3) of the connecting piece (1) to be formed is determined;
b) folding round the sheet metal blank (6) in such a way that the first part (2) and the second part (3) of the connecting piece (1) are formed;
c) plastic deformation of the formed first part (2) and second part (3) of the connecting piece (1) in such a way that said parts can no longer spring open;
d) at least partial provision of internal screw thread (4) in the first part (2) of the connecting piece (1).

9. Method according to claim 8, wherein the first part (2) and the second part (3) of the connecting piece (1) comprise lateral edges (7), the first part (2) and second part (3) of the connecting piece (1) being plastically deformed in such a way that the lateral edges (7) of said parts (2, 3) virtually touch each other.

10. Method according to claim 4, wherein the sheet metal blank (6) is provided with one or more lips (8) which, after the folding process of the sheet metal blank (6), form the one or more connecting elements (5a-b), the folding of said lips (8) to form the one or more connecting elements (5a-b) being performed during the folding process of the sheet metal blank (6) to form the connecting piece (1).

11. Method according to claim 6, wherein the sheet metal blank (6) is provided with at least a first lip (8a) which, after the folding process of the sheet metal blank (6), forms the abovementioned first connecting elements (5a), the folding of said first lip(s) (8a) being performed during the stepwise folding of the second part (6b) of the sheet metal blank (6) (step a) with such a fold angle that, after folding of the sheet metal blank (6) to form the connecting piece (1), the abovementioned connecting elements (5a) can be fixed on the front side of the floor squeegee or window squeegee.

12. Method according to claim 11, wherein the sheet metal blank (6) is provided with at least two second lips (8b) extending around the abovementioned first lip(s), which second lips, after the folding process of the sheet metal blank (6), form the abovementioned connecting elements (5b), the folding of said second lips (8b) being performed in two steps:
1. flattening the second lips (8b) after the plastic deformation of the first part (2) and second part (3) of the connecting piece (1) (step c)
2. folding over the second connecting elements (5b) with such a fold angle that said connecting elements can be fixed on the rear side of the floor squeegee or window squeegee.

13. Method according to claim 7, wherein folding round the sheet metal blank (6) (step b) is carried out in various successive moulds.

14. Method according to claim 7, wherein internal screw thread (4) is at least partially produced by means of a mandrel which is provided with a corresponding external screw thread, in this way at least two grooves being made in the sheet metal blank (6).

15. Method according to claim 9, wherein the lateral edges (7) which substantially touch each other after the plastic deformation of the sheet metal blank (6) are welded together by laser welding.
